(19) United States
(12) Patent Application Publication
(10) Pub. No.: US 2005/0120834 A1
(43) Pub. Date: Jun. 9, 2005

(54) Ratchet wrench

(76) Inventor: Chih-Min Chang, Chang Hua Hsien (TW)

Correspondence Address: BACON & THOMAS, PLLC, 625 SLATERS LANE, FOURTH FLOOR, ALEXANDRIA, VA, 22314, US

(21) Appl. No.: 10/726,601

(22) Filed: Dec. 4, 2003

(51) Int. Cl. B25B 13/46

(52) U.S. Cl. 81/60

(57) ABSTRACT

A ratchet wrench includes a handle having a hole for accommodating a ratchet wheel and a pawl therein. The ratchet has a first teeth portion detachably meshed with a second teeth portion of the pawl. The ratchet wheel is rotatably mounted in the hole of the handle and has two engagement portions oppositely protruded out of the hole of the handle. Two annular members each have an outer diameter greater than a diameter of the hole of the handle and a hole firmly fitted onto the engagement portions of the ratchet wheel respectively.

### BACKGROUND OF THE INVENTION

1. Field of the Invention

The present invention relates to a hand tool, and more particularly to a ratchet wrench which is easy in assembly.

2. Description of the Related Art

A conventional ratchet wrench consists of a handle, a ratchet wheel and a pawl. The handle is provided with a hole at an end thereof for accommodating the ratchet and the pawl therein. On a sidewall of the hole has an annular recess, in which a C-ring is mounted to secure the ratchet and the pawl.

Basically, it is complicated in processing the annular recess on the sidewall of the hole of the handle. It needs a specific machine tool to mill the recess. It also needs pointed pliers to mount the C-ring in the recess. The C-ring makes variations for fabrication and makes more difficult for assembly.

An earlier invention, i.e. U.S. Pat. No. 6,591,718, of the present inventor provides a ratchet wrench, which is easier to assembly than the above-mentioned conventional ratchet wrench. The present invention is another design of the present inventor to provide a ratchet wrench which also has functions of reducing cost, increasing the efficiency of fabrication and reducing the proportion of defective.

### SUMMARY OF THE INVENTION

The primary objective of the present invention is to provide a ratchet wrench, which is easier for assembly and fabrication so as to reduce the cost of fabrication.

The secondary objective of the present invention is to provide a ratchet wrench, which works stably.

To achieve aforesaid objectives of the present invention, a ratchet wrench comprises a handle having a hole for accommodating a ratchet wheel and a pawl therein. The ratchet has a first teeth portion detachably meshed with a second teeth portion of the pawl. The ratchet wheel is rotatably mounted in the hole of the handle and has two engagement portions oppositely protruded out of the hole of the handle. Two annular members are respectively fastened to the engagement portions of the ratchet wheel. Each of the annular members has an outer diameter greater than a diameter of the hole of the handle.

The annular members are preferably fastened to engagement portions of the ratchet wheel by an interfere fit respectively, and the engagement portions and annular members are provided with an embossment respectively at where they are fitted to each other in order to enhance the connection strength therebetween. The annular members can also be fastened to engagement portions of the ratchet wheel by screw threads.

In additional, one of the annular members is preferably integrally formed on the ratchet wheel as an annular flange at an end of the ratchet wheel directly.

The annular members are preferably made of a plastic material for reduction of the cost of fabrication. The plastic annular member also has a lighter weight and a superior flexibility.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is an enlarge sectional view of a part of the first preferred embodiment of the present invention;

FIG. 4 is an exploded view of a second preferred embodiment of the present invention;

FIG. 5 is a partial sectional view of a third preferred embodiment of the present invention, and

FIG. 6 is an exploded view of a fourth preferred embodiment of the present invention.

### DETAILED DESCRIPTION OF THE INVENTION

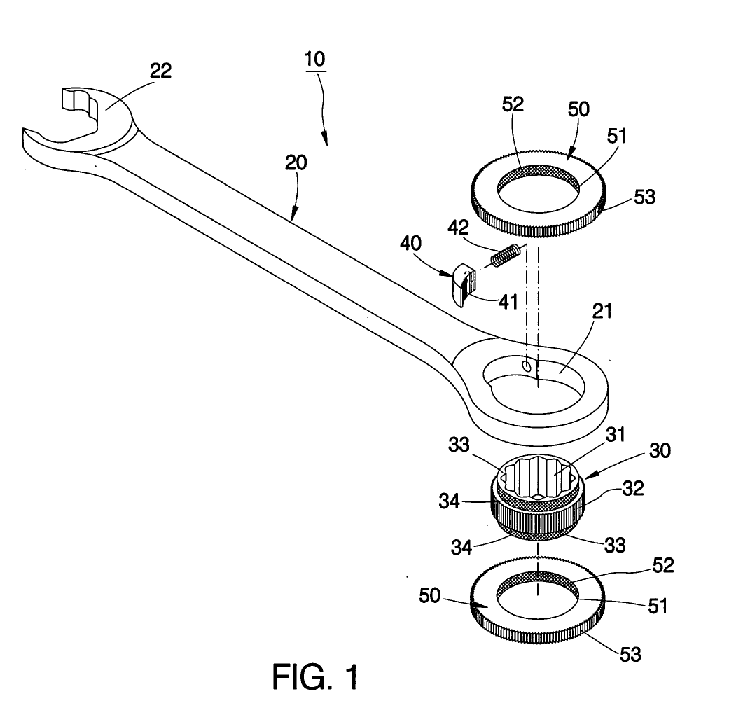

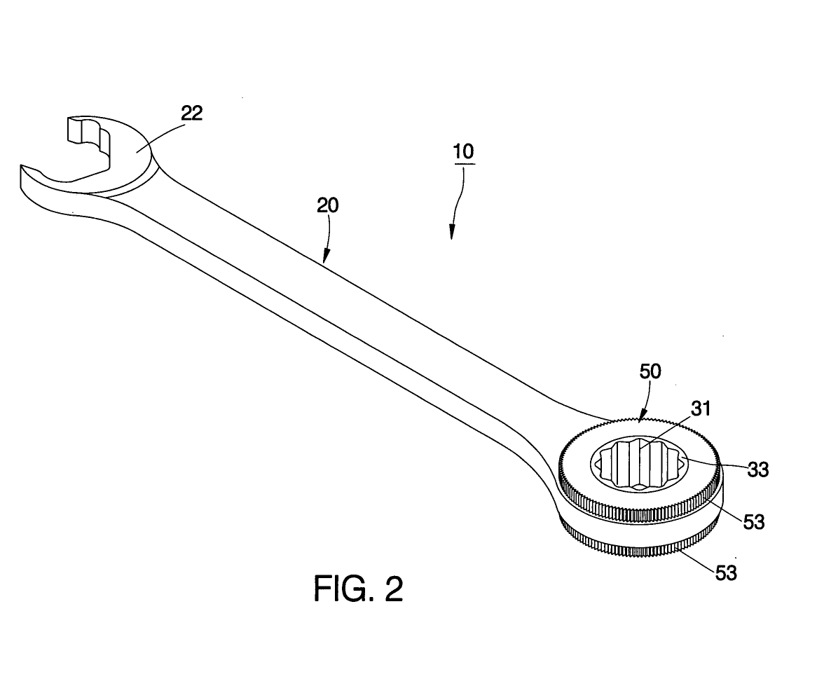

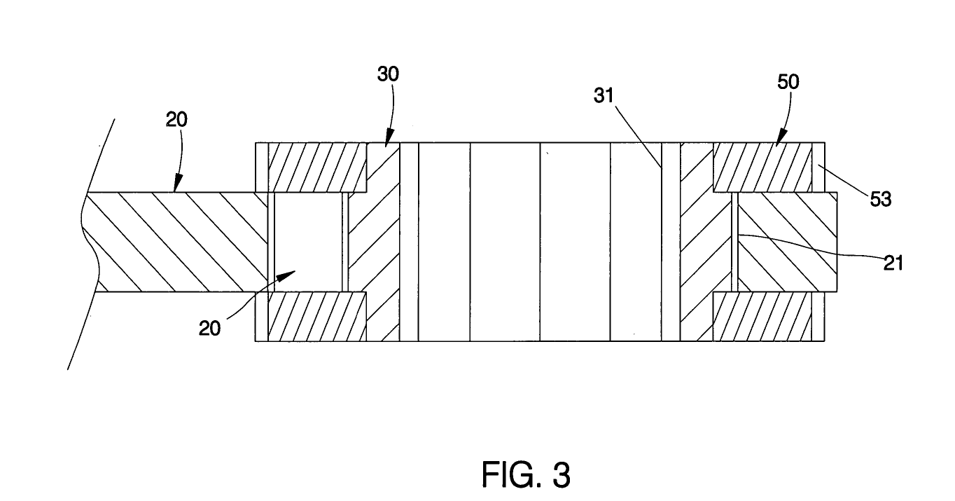

Please refer to FIGS. from FIG. 1 to FIG. 3, a ratchet wrench 10 of the first preferred embodiment of the present invention mainly comprises a handle 20, a ratchet wheel 30, a pawl 40 and two annular members 50.

The handle 20 is provided with a hole 21 at an end thereof and an open wrench portion 22 at the other end thereof.

The ratchet wheel 30 is mounted in the hole 21 of the handle 20 for free rotation. The ratchet wheel 20 has a polygonal hole 31 at a center for engagement with a nut, a bolt and the like. The ratchet wheel 30 is provided with a first teeth portion 32 at an annular outer surface thereof and two engagement portions 33 at opposite sides of the first teeth portion 31, wherein the engagement portions 32 protrude out of the hole 21 of the handle 20 and are provided with an embossment 34 respectively on outer surfaces thereof. The engagement portions 32 are tube-like elements and are integrally formed on the ratchet wheel 30.

The pawl 40 is mounted in the hole 21 of the handle 20 beside the ratchet wheel 30. The pawl 40 has a second teeth portion 41 to be detachably mashed with the first teeth portion 32 of the ratchet wheel 30. A spring 42 is mounted in the hole 21 of the handle 20 to push the pawl 40 laterally. The pawl 40 and the spring 42 are conventional elements, so they need not to be described in detail here.

The annular members 50 each have a hole 51 respectively. Diameters of the holes 51 are substantially equal to outer diameters of the engagement portions 33 of the ratchet wheel 30 respectively. The annular members 50 each have an outer diameter greater than a diameter of the hole 21 of the handle 20. The annular members 50 are provided with an embossment portion 52 respectively on sidewalls of the holes 51. The annular members 50 are press-fitted to the engagement portions 32 of the ratchet wheel 30 in interfere fit so that the ratchet wheel 30, the pawl 40 and the spring 42 are mounted in the hole 21 of the handle 20 quickly.

The annular members 50 can be made of a metal material or a plastic material and on outer surfaces of which are provided with an embossment portion 53 respectively. The embossment portions 53 of the annular members 50 make the user easier to grip them.

The way of assembling the ratchet wrench 10 of the present invention is very easy. It only needs to press the annular members 50 onto the engagement portions 32 of the ratchet wheel 30 respectively after the ratchet wheel 30, the pawl 40 and the spring 42 are mounted in the hole 21 of the handle 20. It also reduces the proportion of defective.

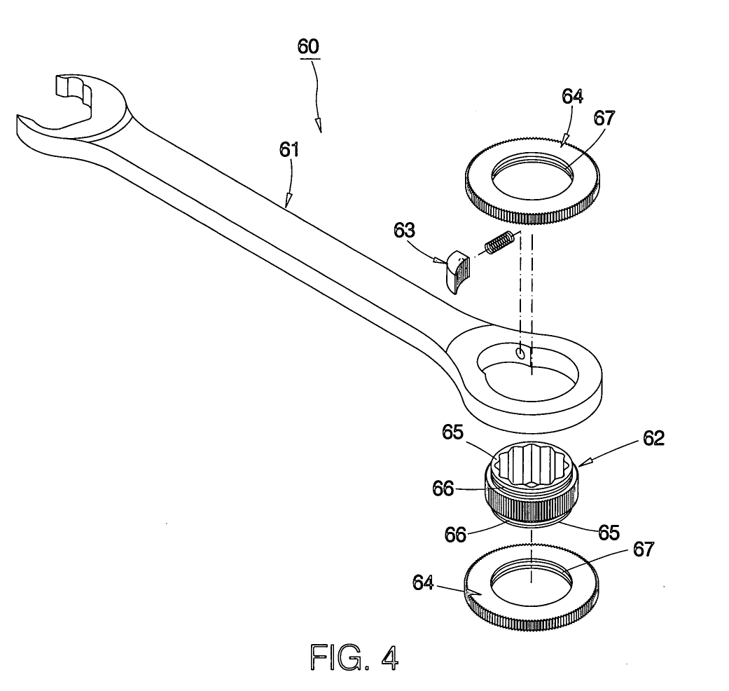

FIG. 4 shows a ratchet wrench 60 of the second preferred embodiment of the present invention, which is similar to the ratchet wrench 10 of the first preferred embodiment, having a handle 61, a ratchet wheel 62 having two engagement portions 65, a pawl 63 and two annular members 64. The engagement portions 65 of ratchet wheel 62 and the annular members 64 are provided with a thread 66 or 67 respectively so that the annular members 64 are mounted to the engagement portions 65 of ratchet wheel 62 by screwing.

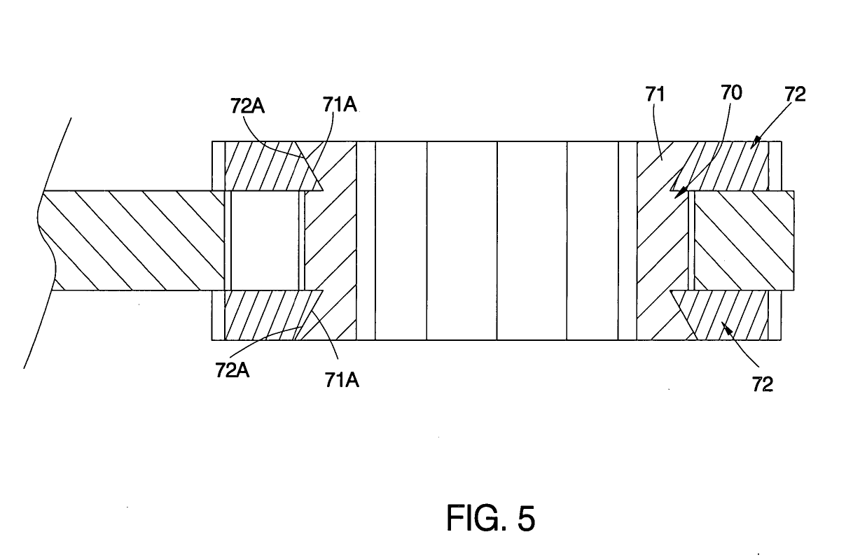

FIG. 5 shows a ratchet wrench 70 of the third preferred embodiment of the present invention, wherein engagement portions 71 of a ratchet wheel 70 and annular members 72 are provided with a slope surface 71A or 72A respectively. The slope surfaces 71A and 72A, which are matched with each other, make the annular members 72 not escaping from the engagement portions 71 of the ratchet wheel 70.

It has to be mentioned that the ways of how to mount the annular members on the engagement portions of the ratchet wheel are various and they are not the main scope of the present invention and should not be only limited in the structures shown in the preferred embodiments. Any structure of making the annular members mounted on the engagement portions of the ratchet wheel stably will be within the scope of the present invention.

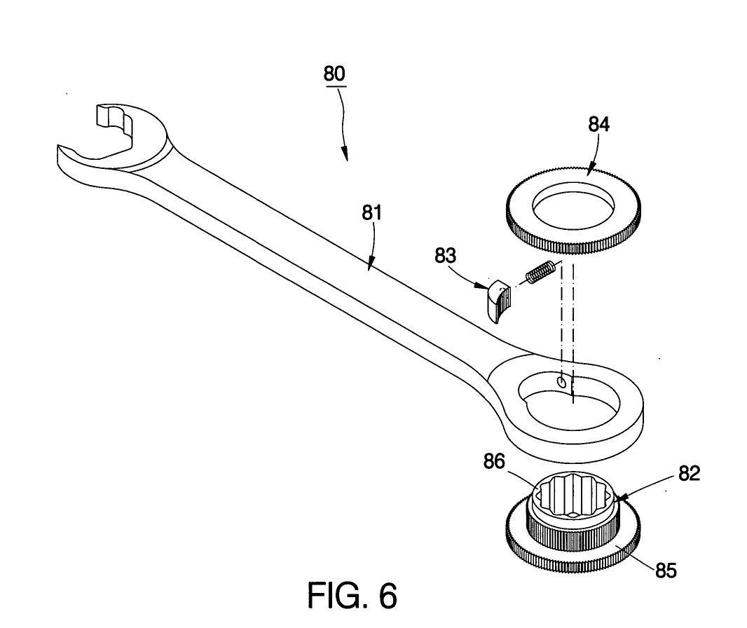

FIG. 6 shows a ratchet wrench 80 of the fourth preferred embodiment of the present invention having a handle 81, a ratchet wheel 82, a pawl 83 and an annular member 84, wherein the ratchet wheel 82 is provided with an annular flange 85 at an end thereof and an engagement portion 86 at the other end thereof. The annular flange 85 has an outer diameter greater than a diameter of the hole of the handle where the ratchet wheel 82 and the pawl 83 are mounted therein.

In conclusion, the present invention provides the annular members mounted to the engagement portions of the ratchet wheel that make the ratchet wrench can be assembled quickly. In additional, the cost of fabrication is reduced therefore and the ratchet wrench works stably.

1. A ratchet wrench, comprising:
a handle having a hole at an end thereof;
a ratchet wheel having a polygonal hole at a center thereof, a first teeth portion at an annular outer surface thereof, and two engagement portions disposed respectively at opposite ends thereof, said ratchet wheel being rotatably mounted in said hole of the handle with the engagement portions protruded out of the hole of said handle;
a pawl mounted in the hole of said handle and having a second teeth portion detachably meshed with said first teeth portion of said ratchet wheel, and
two annular members firmly fastened to the engagement portions of the ratchet wheel respectively, each of said annular members having an outer diameter greater than a diameter of the hole of said handle.

2. The ratchet wrench as defined in claim 1, wherein said engagement portions of said ratchet wheel are coaxially annularly disposed at said annular outer surface at the opposite sides of said first teeth portion.

3. The ratchet wrench as defined in claim 2, wherein said two annular members are provided at a center thereof with a hole having a diameter substantially equal to a diameter of one of said engagement portions of said ratchet wheel such that said two annular members are firmly fastened to said engagement portion of said ratchet wheel by fitting said engagement portion of said ratchet into the hole of said two annular members.

4. The ratchet wrench as defined in claim 1, wherein said two annular members are made of a plastic material.

5. The ratchet wrench as defined in claim 3, wherein said two annular members are provided with an embossment at a wall of the hole thereof.

6. The ratchet wrench as defined in claim 1, wherein said ratchet wheel is provided with embossments on said engagement portions of said ratchet wheel respectively.

7. The ratchet wrench as defined in claim 1, wherein said two annular members are fastened to said engagement portions of said ratchet wheel by screw threads respectively.

8. The ratchet wrench as defined in claim 1, wherein said engagement portions of said ratchet wheel and said two annular members are respectively provided with a slope surface engaged with each other.

9. A ratchet wrench, comprising:
a handle having hole at an end thereof;
a ratchet wheel having a polygonal hole at a center thereof, a first teeth portion at an annular outer surface thereof, an engagement portion at an end thereof and an annular flange at the other end thereof, wherein said annular flange has an outer diameter greater than a diameter of the hole of said handle, said ratchet wheel being rotatably mounted in the hole of said handle with said engagement portion and said annular flange protruded out of the hole;
a pawl mounted in the hole of said handle and having a second teeth portion detachably meshed with said first teeth portion of said ratchet wheel, and
an annular member having an outer diameter greater than the diameter of the hole of said handle, wherein said annular member is firmly fastened to said engagement portion of said ratchet wheel.

10. The ratchet wrench as defined in claim 9, wherein said engagement portion of said ratchet wheel is coaxially annually disposed at said annual outer surface.

11. The ratchet wrench as defined in claim 9, wherein said annular members are provided at a center thereof with a hole having a diameter substantially equal to a diameter of said engagement portion of said ratchet wheel such that said annular members are firmly fastened to said engagement portion of said ratchet wheel by fitting said engagement portion of said ratchet into the hole of said annular members member.

12. The ratchet wrench as defined in claim 9, wherein said annular member is made of a plastic material.

13. The ratchet wrench as defined in claim 1 1, wherein said annular member is provided with an embossment at a wall of the hole thereof.

14. The ratchet wrench as defined in claim 9, wherein said ratchet wheel is provided with an embossment on said engagement portion of said ratchet wheel.

15. The ratchet wrench as defined in claim 9, wherein said annular member is fastened to said engagement portion of said ratchet wheel by screw threads.

16. The ratchet wrench as defined in claim 9, wherein said engagement portion of said ratchet wheel and said annular member are respectively provided with a slope surface engaged with each other.

17. A ratchet wrench, comprising:
a handle having a hole at an end thereof;
a ratchet wheel having a polygonal hole at a center thereof, a first teeth portion at an annular outer surface thereof, and two engagement portions disposed respectively at opposite ends thereof, said ratchet wheel being rotatably mounted in the hole of said handle with the engagement portions protruded out of the hole of said handle, each of said engagement portions having an outer surface;
a pawl mounted in the hole of said handle and having a second teeth portion detachably meshed with said first teeth portion; and
two annular members each having an inner surface firmly fastened to an outer surface of a corresponding one of said engagement portions, with each annular member having an outer diameter greater than a diameter of the hole of said handle

18. The ratchet wrench as defined in claim 17, wherein said outer surface of each of said engagement portions and said inner surface of each of said annular members have embossment formed thereon which are mutually engaged to effect said firmly fastened condition.

19. The ratchet wrench as defined in claim 17, wherein said outer surface of each of said engagement portions and said inner surface of each of said annular members have threads formed thereon which are mutually engaged to effect said firmly fastened condition.
